(19) United States
(12) Patent Application Publication
(10) Pub. No.: US 2002/0105434 A1
(43) Pub. Date: Aug. 8, 2002

(54) Remote finder

(76) Inventor: Majid Ghaznavi, Dallas, TX (US)

Correspondence Address: MAJID GHAZNAVI, P.O. Box 835411, RICHARDSON, TX, 75080, US

(21) Appl. No.: 09/728,877

(22) Filed: Feb. 5, 2001

(51) Int. Cl. H04L 17/02; G08C 19/12

(52) U.S. Cl. 340/825.72; 341/176

(57) ABSTRACT

This new device is of nonexistence in the market place and will be of benefit, and helpful recover misplaced remotes.

### BRIEF SUMMARY OF THE INVENTION

“Remote Finger” is essentially an optional device set that locates remote controls which are separated from their sources, such as TV, VCR, Remote Control Toys, and Etc.

“Remote Finder” is a device consist of tow parts.

Part One) An electronic transmitter with a short range of 500 ft. to 100 ft. transmission radius.

Part Two) An electronic “receiver”, receiving same frequency of transmission from Part One (Transmitter), and is installed on the Remote Control Unit.

Part One “Transmitter” is installed on the source unit such as VCR, and has a battery or low voltage electronic source to be powered. This part has the transmission button, which will send the short range frequency to the Part Two “Receiver”.

Receiver is powered by a battery, and is able to receive transmissions from the source unit, and announce it by a built in signal or miniature horn.

In times of a lost remote control by pressing the source transmitter one should be able to locate the remote by following the special signal coming from the receiver.

I claim:

1. A device which will enable one to find a missing remote control of certain item operated with such remote.
